(19) United States
(12) Patent Application Publication
(10) Pub. No.: US 2011/0009782 A1
(43) Pub. Date: Jan. 13, 2011

(54) DERMAL ROLLER WITH THERAPEUTIC MICROSTRUCTURES

(75) Inventors: Erik Jon Raymond Pampalone, Chatsworth, CA (US); Stacey Marie Patterson, Ferndale, WA (US); Michael Lowe, Santa Cruz, CA (US)

Correspondence Address: KNOBBE MARTENS OLSON & BEAR LLP, 2040 MAIN STREET, FOURTEENTH FLOOR, IRVINE, CA, 92614, US

(73) Assignee: NAYA TOUCH, INC., Chatsworth, CA (US)

(21) Appl. No.: 12/832,012

(22) Filed: Jul. 7, 2010

Related U.S. Application Data
(60) Provisional application No. 61/223,540, filed on Jul. 7, 2009.

(51) Int. Cl. A61H 15/00

(52) U.S. Cl. 601/119

(57) ABSTRACT

A microstructure roller apparatus including a handle, an axle, a retention mechanism and a roller cartridge is disclosed herein. The handle can have an axle at one end and a grip portion at the other end. A generally cylindrical roller cartridge can be coupled to the axle by inserting the axle into a central lumen of the roller cartridge. A retention mechanism on the axle can hold the roller cartridge to the axle. The cartridge can include multiple strips that have an array of microstructures along the length and width of each strip. The handle can be weighted to provide a correct amount of pressure to the patient.

### CROSS-REFERENCE TO RELATED APPLICATIONS

The present application claims priority under 35 U.S.C. §119(e) to U.S. Provisional Application No. 61/223,540 filed on Jul. 7, 2009, the disclosure of which is incorporated by reference herein in its entirety.

### TECHNICAL FIELD

The disclosure relates in general to the field of dermal rollers, including rollers having microstructures suitable for treating dermal areas, such as for improved drug delivery and cosmetic enhancement.

### BACKGROUND

The effectiveness of certain cosmetic and medical skin treatments can be enhanced by controlling penetration of the cosmetic or medicine through or into the skin. Microstructures may be used in connection with cosmetic and medical skin treatments to penetrate the skin surface to deliver substances at greater than surface depths. Microstructures can be used to enhance penetration of compounds applied before, during or after treatment with the microstructures. For example, some tattoo artists use microstructure technology to allow penetration of topical anesthetic before and during procedures. Rollers having microstructures can be used to efficiently apply the microstructures to dermal areas for drug delivery and cosmetic use.

In addition, certain cosmetic companies promote microstructure technology as able to stimulate collagen growth and reduce wrinkles. Skin penetration with microstructures helps accelerate collagen growth, which results in softened skin lines, improved healing, reduced scarring, skin tightening (sometimes referred to as an “anti-aging” effect) and thickened skin. Minute wounds formed in the skin from the microstructures stimulate the body to create collagen, and through the body's natural healing process, tighter, improved skin quality results.

Various apparatuses and methods of using microstructure rollers are described in U.S. Pat. Nos. 5,697,901; 6,663,820; 7,262,068, and 7,226,439, as well as U.S. Patent Application Publication Nos. 2006/0051404 and 2008/0161735, which are all hereby incorporated by reference herein in their entireties.

There still exists a need, however, to provide microstructure rollers that include less-invasive needles, induce less pain, and/or do not become deformed over time. There is also need for microstructure rollers that stimulate the skin uniformly and do not detach from the roller during use. Furthermore, microstructure rollers can become contaminated when assembled by the end user.

### SUMMARY OF THE DISCLOSURE

An aspect of at least one of the embodiments disclosed herein includes the realization that there is a need for an easy to use, sterile microstructure roller system that can reliably and effectively treat large dermal areas.

A microstructure roller apparatus disclosed herein enables efficient application of microstructure technology to a dermal layer. The microstructure roller apparatus includes a handle and a therapeutic cartridge. The handle includes an axle that extends in a direction transverse to the handle's longitudinal axis. The axle includes a retention mechanism, such as a quick connect, quick release, or other structure that allows the roller to be secured to axle while allowing the roller to rotate about the axle's longitudinal axis. The roller includes multiple microstructures, generally arranged in an array along the roller's outer surface.

The microstructures are applied to a patient's skin by holding the handle and rolling the cartridge across the patient's dermal area. Drugs or topical aides can be applied to the dermal area before, during or after treatment with the roller apparatus. The retention mechanism can be manipulated to release the roller cartridge from the handle, such that the roller cartridge is easily removable and replaceable.

In one embodiment, the roller apparatus is configured to allow sterile attachment of the roller to the handle. For example, the handle can be configured to attach to the roller without directly touching the roller. In one such embodiment, one end of the handle's axle is attached to the handle and the other end is unattached. A gap between the axle outer surface (or diameter) and the handle is sized to receive a roller container. The roller container includes a sealed, sometimes sterilized container and a microstructure roller. When the cover is removed from the roller container, the axle can be inserted into a receiving lumen of the microstructure roller while the user holds the handle in one hand and the roller container in the other.

Thus, in accordance with at least one of the embodiments disclosed herein, a handheld roller assembly for treating a patient's dermal surface can comprise a handle having a longitudinal axis, a proximal end and a distal end. The assembly can also include an axle disposed toward the distal end of the handle, the axle extending substantially transverse to the longitudinal axis of the handle. A roller cartridge having an outer surface and lumen configured to slideably receive the axle can be attached to the assembly, the lumen extending longitudinally along a central axis of the roller cartridge. The assembly can have a quick-release mechanism configured to secure the roller cartridge to the axle and release the roller cartridge from the axle. On the outer surface of the roller cartridge can be a plurality of microstructures extending normal to the outer surface.

In some embodiments, the quick release mechanism can comprise a tab configured to detachably hold the roller cartridge on the axle while not impeding rotational movement of the roller cartridge about its longitudinal axis. The quick release mechanism can be configured to be manipulated by a thumb of a user's hand when the user's hand is holding the handle.

In some embodiments, the handle can have a weight configured to provide a therapeutic pressure to the patient's dermal surface during use.

In some embodiments, at least a portion of the roller cartridge can have a diameter greater than 25 millimeters. The roller cartridge can have a substantially constant diameter along the roller cartridge length. The roller cartridge can have a length greater than 70 millimeters.

In some embodiments, the roller cartridge can have a frustoconical shape. The outer surface can taper at an angle of at least 0.5 degrees with respect to the roller cartridge central axis.

In some embodiments, the microstructures are integrally formed with the roller cartridge. The roller cartridge can be formed by injection molding. The microstructures can be spaced approximately 4 millimeters from each other. In some embodiments, at least the outer surface of the roller cartridge and microstructures can be made of a polyamide copolymer with glass fibers.

In some embodiments, the microstructures on the handheld roller assembly can be arranged in rows disposed along the length of the outer surface. The roller cartridge can comprise approximately 9 microstructures per square centimeter over the outer surface of the roller cartridge. The microstructures can have a height of at least 0.1 mm. In some embodiments, the microstructures can comprise pyramids having three sides. In other embodiments, the microstructures can comprise pyramids having four sides. The microstructures can comprise microneedles.

In some embodiments, the roller cartridge can comprise a cartridge base and at least one microstructure strip coupled to the cartridge base. The microstructure strip can comprise more than one row of microneedles disposed along the length of the microstructure strip.

In some embodiments, the spacing along the handle longitudinal axis between the handle and the axle can be sufficient to allow the axle to be inserted into a container housing the roller cartridge to attach the roller cartridge to the axle.

In accordance with at least another of the embodiments disclosed herein, a roller assembly for treating a patient's dermal surface can comprise a handle, the handle comprising a projecting portion that projected from the handle in a direction transverse to a longitudinal axis of the handle. A roller cartridge can be configured to slide over the projecting portion of the handle. A coupling member can be configured to automatically lock the roller cartridge to the handle without preventing rotation of the roller cartridge with respect to the handle, and can be further configured to release the roller cartridge from the handle when activated by a user. A plurality of microstructures can extend normal to an outer surface of the roller cartridge.

A method of using the roller assembly can comprise the step of providing a handle configured to receive a roller cartridge, the handle comprising a quick-release mechanism for coupling and releasing the roller cartridge to the handle. A sterile roller cartridge can be provided in a protective container, the roller cartridge comprising a plurality of microneedles extending normal to an outer surface of the roller cartridge. The handle can be inserted in the roller cartridge while the roller cartridge is in the protective container until the quick-release mechanism locks the handle to the roller cartridge.

In some embodiments, the roller cartridge can be extracted from the container. The quick-release mechanism can be manipulated to detach the roller cartridge from the handle.

### BRIEF DESCRIPTION OF THE DRAWINGS

Specific embodiments and modifications thereof will become apparent to those skilled in the art from the detailed description herein having reference to the figures that follow, of which:

FIG. 1 is a schematic isometric view of a roller assembly comprising a handle and cartridge, according to an embodiment of the present application.

FIG. 2 is a schematic isometric view of the handle of FIG. 1.

FIG. 3 is an exploded schematic isometric view of a handle comprising a grip portion of the handle and an axle, according to an embodiment of the present application.

FIGS. 4A-C are various schematic views of the grip portion of the handle of FIG. 3.

FIGS. 5A-C are various schematic views of the axle of FIG. 3.

FIGS. 6A-B are various schematic view of the retention mechanism of FIG. 2.

FIG. 7 is a schematic isometric view of a cartridge, according to an embodiment of the present application.

FIG. 8 is a close-up view of a 3-sided microstructure.

FIG. 9 is a close-up view of a 4-sided microstructure.

FIG. 10A is a schematic isometric view of a cartridge comprising a cartridge base and microstructure strips, according to another embodiment of the present application.

FIG. 10B is an exploded schematic isometric view of the cartridge of FIG. 10A.

FIG. 11 is a schematic isometric view of the cartridge base of FIG. 10A.

FIG. 12 is a schematic isometric view of a microstructure strip, according to an embodiment of the present application.

FIG. 13 is a schematic isometric view of a frustoconical shaped cartridge illustrating a microstructure strip detached from the cartridge base, according to an embodiment of the present application.

FIG. 14 is a schematic isometric view of another handle, according to an alternative embodiment of the present application.

FIG. 15 is an exploded schematic isometric view a cartridge and a container with a stabilizer and cover, according to an embodiment of the present application.

FIG. 16 is a schematic isometric view of a handle being used to remove a cartridge from a container, according to an embodiment of the present application.

FIG. 17 is a schematic isometric view of the roller assembly being used on a dermal surface of a patient.

### DETAILED DESCRIPTION OF SPECIFIC EMBODIMENTS

Rollers with microstructures that are used to treat dermal areas are described herein. Such microstructure rollers can be particularly advantageous in drug delivery and cosmetic enhancements.

The term “microstructures” is a broad term. In addition to its ordinary meaning, a microstructure also includes a small structure protruding from the outer surface of a roller cartridge that is configured to press against or penetrate the surface of the skin.

In one embodiment, the roller apparatus disclosed herein includes a handle, an axle, a retention mechanism and a roller cartridge. The handle has a mating portion extending from an end of the handle for coupling with the axle. A generally cylindrical roller cartridge is coupled to the axle by inserting the axle into a central lumen of the roller cartridge. A retention mechanism on the axle holds the roller cartridge to the axle. An array of microneedles is provided on an outer surface of the roller cartridge. The microneedles are disposed along the length and circumference of the roller.

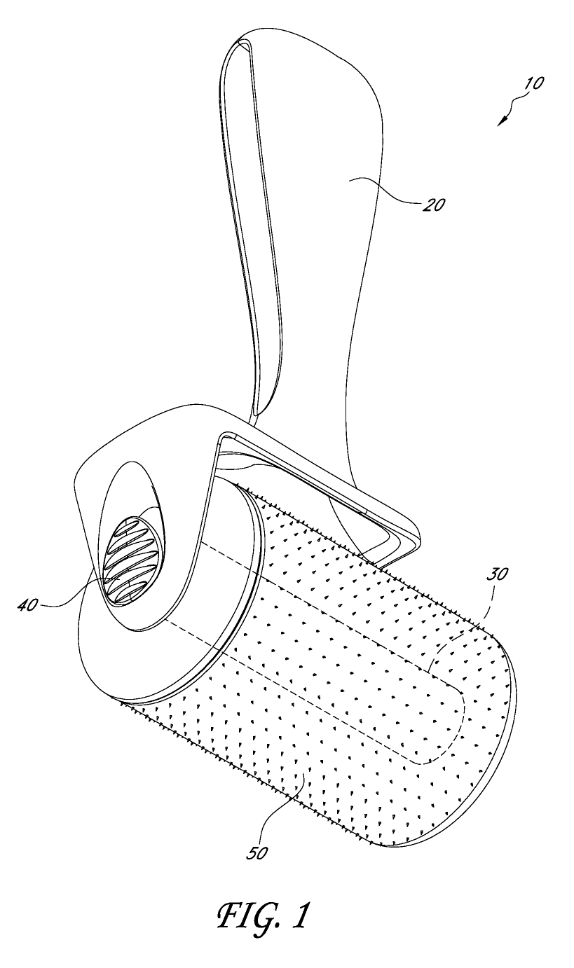

Various microstructure rollers having desirable features and advantages will now be described with reference to the figures. Referring to FIG. 1, in one embodiment, a microstructure roller apparatus 10 includes a handle 20, axle 30, retention mechanism 40 and a cartridge 50. The cartridge 50 is rotatably coupled to the axle 30 and secured by the retention mechanism 40. A technician can use the roller apparatus 10 for treatment by holding the handle 20 and rolling the cartridge 50 on a patient's dermal area (e.g., back, front, stomach, neck, leg, arm, face, etc.). The outer surface of the cartridge 50 includes microstructures to effectuate the desired treatment of the patient.

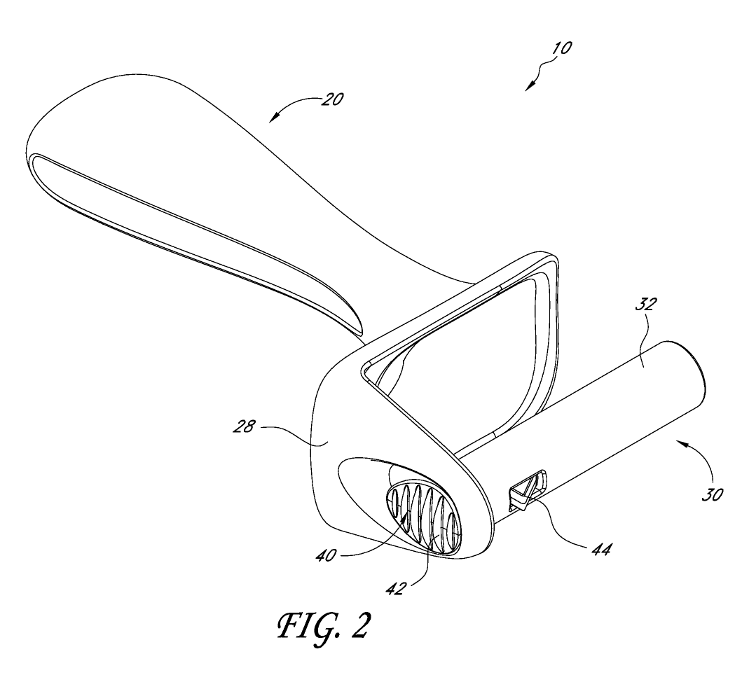

FIG. 2 illustrates an embodiment of the handle 20 of FIG. 1. The handle 20 includes a single axle support 28 that is configured for quick-release coupling with the axle 30. The retention mechanism 40 is configured for easy and efficient coupling and decoupling of the microstructure cartridge 50 from the handle 20. The retention mechanism 40 is disposed on or integrated with the axle 30, and allows releasable coupling of the cartridge 50 to the axle 30.

The handle 20 extends generally along a longitudinal axis. The axle 30 includes an elongate tubular or cylindrical member and configured to be attached at one end to the handle 20, and free at its opposite end. The axle 30 extends in a direction that is generally transverse to the longitudinal axis of the handle 20, as illustrated in FIG. 2.

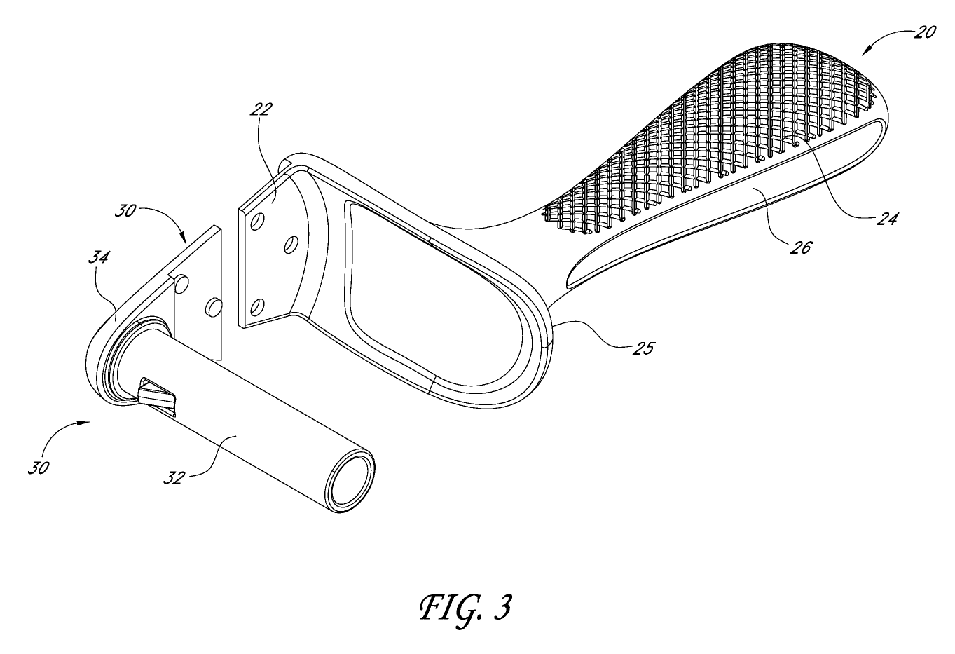

FIG. 3 is an exploded isometric view illustrating one embodiment of the handle 20 and axle 30 of FIG. 2. In the illustrated embodiment, an axle support 28 is formed by joining the handle 20 and axle 30 together. The handle 20 includes a bracket 22 that extends from one side of the handle 20. The axle 30 includes a flange 34 that extends from one end of the axle 30, and configured to attach to the bracket 22. The bracket 22 includes a mating surface complementary to a mating surface on the flange 34, such that the flange 34 can be coupled to the bracket 22. In some embodiments, the bracket 22 and flange 34 are welded. In some embodiments, the bracket 22 can be attached to the flange 34 with fasteners, rivets, adhesives, and/or other attachment mechanisms. In one embodiment, the outer surfaces at the junction of the handle 20 and axle 30 are polished to a smooth finish to eliminate the seam formed between them. The smoothed and polished surface provides an integrated and pleasant appearance to the axle support 28, and also eliminates a crevice in which impurities, dirt, etc., can accumulate. An axle support 28 having such a polished finish is illustrated in FIG. 2.

In some embodiments, the handle 20 and axle 30 include a releasable connection, such as for example a hook on the handle 20 that secures the handle 20 to a complementary slot on the axle 30 (or vice versa). A releasable connection can permit the use of different combinations of handles and axles and allows for greater flexibility during manufacturing. For example, an axle having an increased length can be coupled with the handle to accommodate a wide cartridge that is used to treat very large dermal areas. In another example, a different handle having a lighter weight can be attached to the axle, for use in situations that require the application of less pressure, such as in the treatment of children, or delicate areas, such as areas around the face and/or eyes. In some embodiments, the handle 20 and axle 30 are formed from a single piece of material, such as stainless steel, plastic, aluminum, etc. For example, the handle 20 and axle 30 can be injection molded from a single cast, or machined from a single block of material.

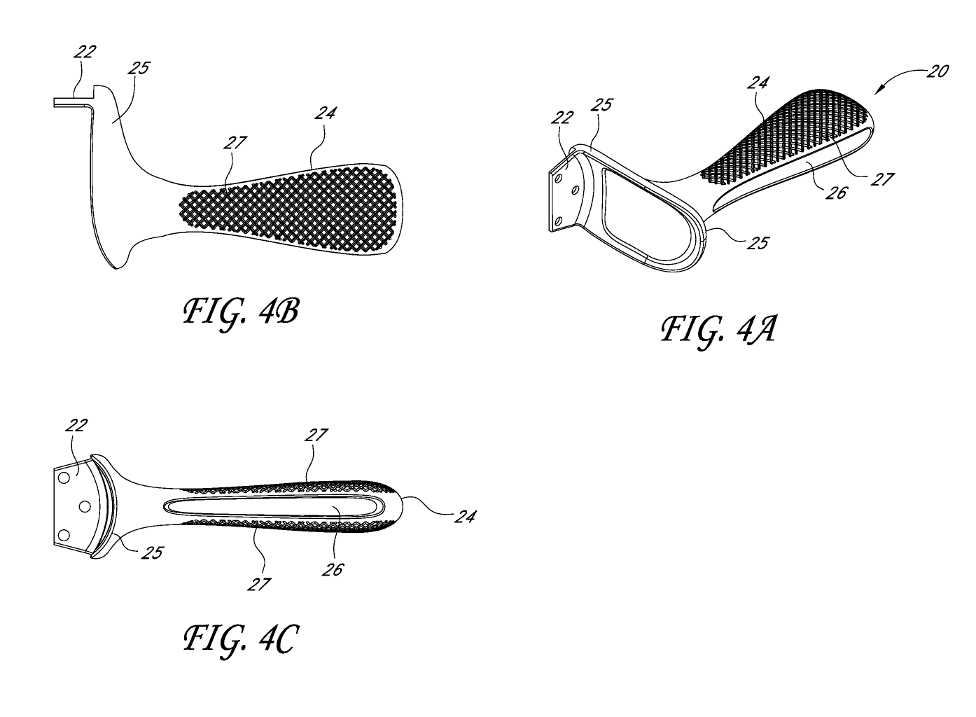

FIGS. 4A-C illustrate various views of an embodiment of the handle 20. The handle 20 includes a grip portion 24 that can be contoured for an ergonomic fit in the user's hand. In the illustrated embodiment, the grip portion 24 has a generally flat, elongate shape with a wide portion at one end and a narrow neck portion on another end, similar in shape to a duck bill shape. The end with the wide portion of the grip portion 24 is rounded and the sides of the grip portion 24 taper inward to create the neck portion toward the other end of the grip portion 24. In other embodiments, the grip portion 24 a shape and surface features suitable for gripping. For example, the grip portion 24 can be a generally cylindrical rod, or an elongate member with a generally rectangular cross-section.

In some embodiments, at least a portion of the grip portion 24 includes a textured surface 27 for enhanced gripping, as illustrated in FIGS. 3-4C. In the illustrated embodiment, the grip portion 24 includes crisscrossing grooves on the surface. In other embodiments, the textured surface 27 includes cavities, grooves, protrusions, or other features to enhance gripping.

In some embodiments, the handle 20 has a flared end 25 that extends generally laterally from the narrow neck. In the illustrated embodiment, the shape of the flared end 25 is blended with the narrow neck for an integrated look. As illustrated in FIG. 4C, the flared end 25 can be curved when viewed from the side. The curvature of the flared end 25 can be configured to provide clearance for a container for the microstructure cartridge 50, as described below. The bracket 22 extends from a side of the flared end 25. In other embodiments, the handle 20 does not have a flared end 25. Instead, the handle 20 can have an arm that extends laterally from the narrow neck, wherein the axle 30 can be attached to an end of the arm.

As illustrated in FIG. 4C, the handle 20 can include an aperture 26 that extends transverse to the longitudinal axis of the handle 20. In the illustrated embodiment, the aperture 26 is slot-shaped and has an elongate shape with rounded ends. In other embodiments, the aperture 26 can have other shapes, such as rectangular. In some embodiments, the handle 20 can have more than one aperture extending through the handle 20, such as a series of circular holes aligned down the side of the handle 20. The aperture 26 can be used as a means to control the weight and the weight distribution in the handle. For example, if additional weight is desired toward the front of the handle, additional material can be added to the narrow neck area of the handle, making the aperture toward the front of the handle smaller. In some embodiments, the handle can be solid and may not have an aperture, in which case the weight and weight distribution can be controlled by the shape of the handle.

The weight of the handle 20 can be configured to provide the correct amount of pressure to the patient's dermal area when the roller apparatus 10 is in use. The microstructures on the cartridge provide optimal therapy when a specific amount of pressure is applied by the microstructures. This pressure can be provided by the calibrated weight of the handle 20. In some embodiments, the weight of the handle 20 is sufficient to provide the correct amount of pressure without the technician having to push or provide additional force to the roller apparatus 10. For example, the handle 20 can have a weight ranging from approximately 100 grams to approximately 3 kilograms. In some embodiments, the weight of the handle 20 can range from approximately 500 grams to approximately 2 kilograms. In preferred embodiments, the handle 20 can have a weight of approximately 1 kilogram. In some embodiments, the handle can have marks or graduations visible on the surface to indicate proper placement of the hand during treatment, as described further below. In some embodiments, the handle 20 can have an aperture, as illustrated in FIG. 4C and described above, to control the amount of material on the handle to provide the proper weight and weight distribution.

The handle 20 can be made of a rigid material, such as metals and/or plastics. In preferred embodiments, the handle 20 can be formed from a heavy metal to provide the correct pressure to the cartridge. For example, the handle 20 can be made of stainless steel, steel, iron, or an alloy. Preferably, the handle 20 is made of a material that is widely available and easily moldable.

In some embodiments, the handle 20 can be formed by casting or injection molding. In other embodiments, the handle 20 can be made by machining. In some embodiments, the handle 20 can be made from a combination of manufacturing techniques. For example, the grip portion 24 can be molded while the bracket 22 can be machined and then welded to the grip portion 24.

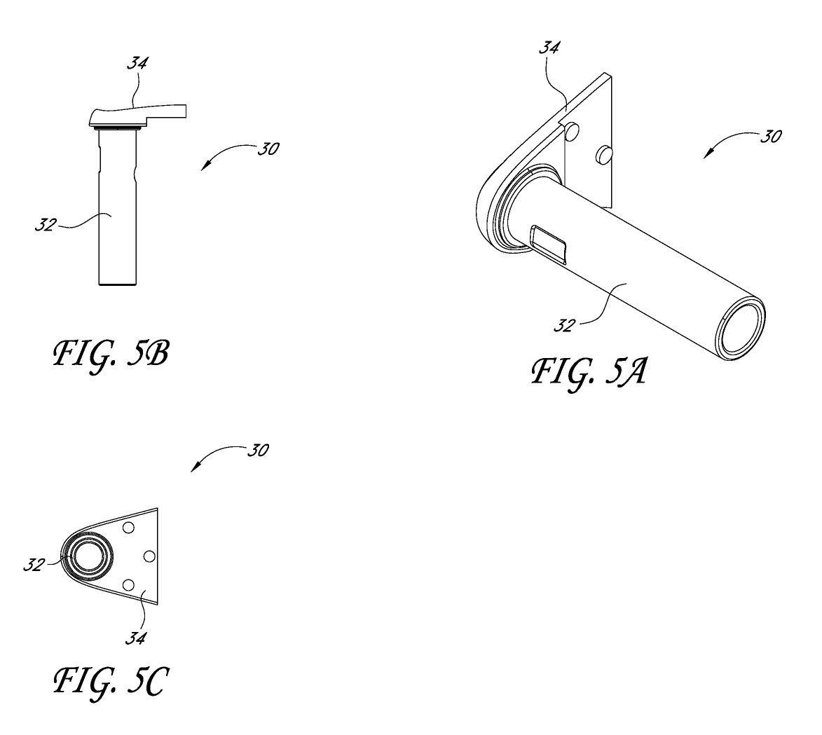

FIGS. 5A-C illustrate various views of an embodiment of the axle 30. In one embodiment, the axle 30 includes an elongate tube 32. In preferred embodiments, the tube 32 can be cylindrical. In the illustrated embodiment, the axle 30 is approximately 70 mm in length and has a diameter of approximately 12 mm. In some embodiments, the axle 30 can have any length and any diameter corresponding to the selected cartridge. In some embodiments, the tube 32 can have an oval, square, rectangular, polygonal, or any other cross sectional shape that fits the central lumen 54 on the cartridge 50.

The axle 30 can have a flange 34 connected to an end of the tube 32. The flange 34 can have a surface that is complementary to a surface on the bracket 22, such that the flange 34 can be mated to the bracket 22, as described above. The tube 32 can be rigidly connected to the flange 34, such as through welding, fasteners, adhesive, and the like. In other embodiments, the tube 32 can be integrally formed with the flange 34 as a single piece. The tube 32 can advantageously be cylindrical so that the cartridge 50 can rotate about the tube 32. In other embodiments, a bearing can be disposed between the tube 32 and the flange 34 to provide rotational freedom for the tube 32 to rotate about its longitudinal axis relative to the flange 34. In these embodiments, the tube 32 can have a non-cylindrical shape to create a non-rotational coupling with the cartridge 50. The cartridge 50 can thus rotate jointly with the rotating tube 32.

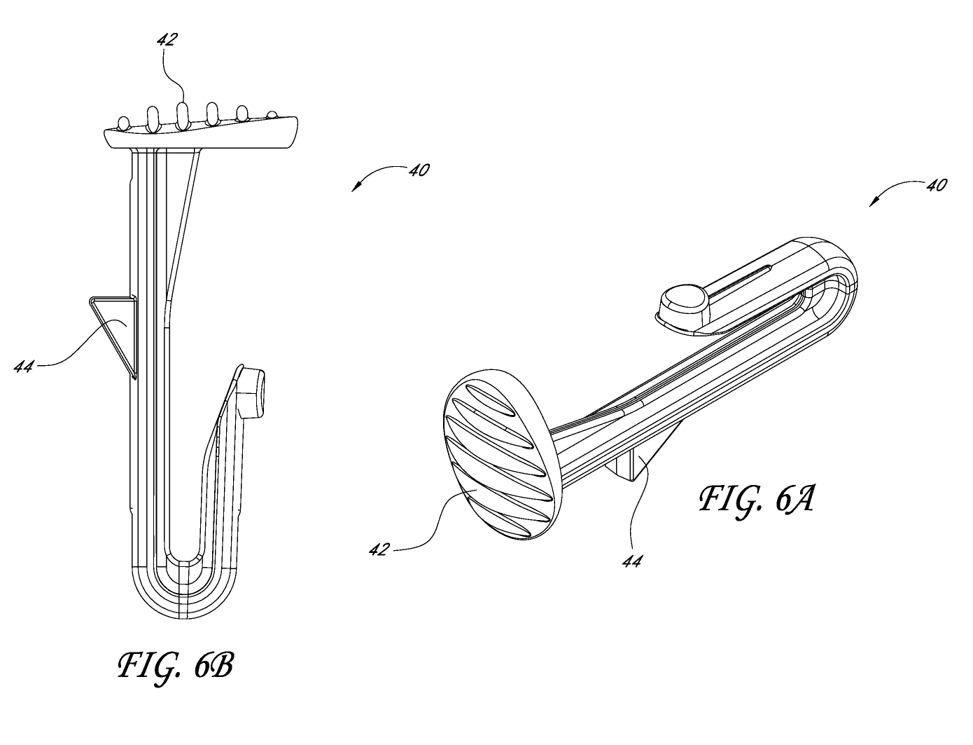

In one embodiment, a retention mechanism 40 is disposed on the axle 30 to hold the cartridge 50 to the axle 30. The retention mechanism 40 has generally a U-shape with one leg of the “U” longer in length than the other leg, as illustrated in FIG. 6A-B. The end of the longer leg of the “U” includes a finger pad 42, which can be manipulated to flex or compress the retention mechanism 40. An angled tab 44 extends from the leg of the “U” attached to the finger pad 42. As illustrated in FIG. 2, the retention mechanism 40 is positioned in the central lumen of the tube 32 such that the angled tab 44 extends through a cutout of the tube 32. The tab 44 can hold the cartridge 50 to the axle 30, without impeding the rotational movement of the cartridge 50 about the axle 30.

To release the cartridge 50 from the axle 30, the user can manipulate the pad 42 in a direction to cause the tab 44 to retract into the tube 32. Once retracted, the cartridge 50 may be removed from (such as slid off) the axle 30. In some embodiments, the user can manipulate the pad 42 with her thumb while holding the handle 20, thereby facilitating quick and easy operation of the retention mechanism 40. Although described with reference to the illustrated embodiment, other embodiments of a retention mechanism 40 can be provided, such as retention mechanisms that include a push button release mechanism, a twisting lock mechanism, etc.

In one embodiment, the retention mechanism 40 is made of a hard, rigid material that rebounds after deformation. Suitable materials include plastics, metals, springs, and/or composites. In one embodiments, the retention mechanism 40 is made of Delrin®. In other embodiments, the retention mechanism is made of a metal, such as aluminum. In some embodiments, the retention mechanism has a hinge at a pivot point at the base of the U-shape and a spring between the legs of the “U” to bias the tab 44 in an outward (or inward) direction.

### Cartridge

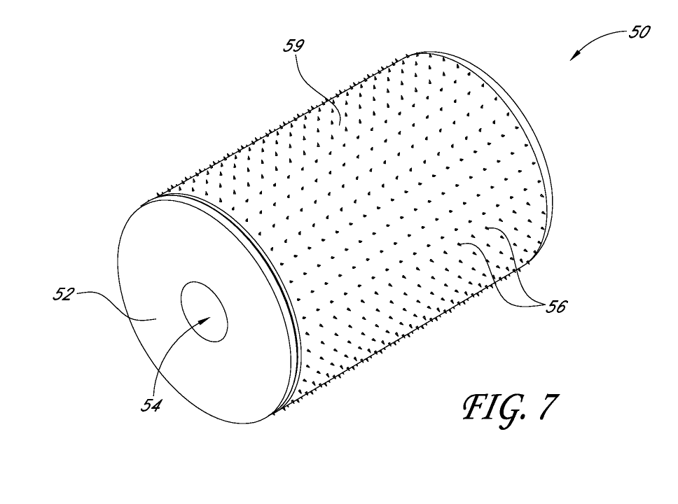

FIG. 7 illustrates one embodiment of a microneedle cartridge 50. The microneedle cartridge 50 includes a base portion 52 and microstructures 56 disposed on the cartridge's 50 outer surface 59. The base 52 includes a an opening that provides access to lumen 54 that extends through the center of the cartridge 50 along the cartridge's central axis. The lumen 54 is configured to receive the axle 30. The outer surface 59 of the cartridge 50 includes an array of microstructures 56 that are configured to create small punctures in the dermal areas of the patient.

In some embodiments, a plurality of microstructures 56 are disposed along the length and circumference of the outer surface 59 of the cartridge 50. The microstructures 56 can include protrusions that extend generally normal to the outer surface 59 of the cartridge 50. In some embodiments, the microstructures 56 can have a width at their base and the sides can taper inward toward a pointed top, similar to a pyramid shape, as described further below. The height is sufficient to create punctures in the patient's derma, which in some embodiments is at least about 0.1 mm. In some embodiments, the height of the microstructures 56 is about 0.35 mm. The width of the microstructures 56 is small enough to puncture dermal areas, yet wide enough to provide structural strength to withstand the pressures during treatment. In one embodiment, the width at the base of the microstructures 56 is preferably about 0.17 mm.

In one embodiment, the spacing between microstructures 56 is selected for effective patient treatment. For example, in some embodiments, the distance between microstructures 56 is about 4 mm. In some embodiments, the spacing between microstructures 56 is in the range of from about 2 mm to about 6 mm. In some embodiments, the spacing between microstructures 56 is in the range of from about 3 mm to about 5 mm. Similarly, the density of microstructures on the outer surface 59 can be selected for effective patient treatment. In one embodiment, the density is about 9 structures per cubic centimeter. In other embodiments, the density is in the range of from about 4 needles per square centimeter to about 20 needles per square centimeter. In some embodiments, the density is in the range of from about 6 needles per square centimeter to about 15 needles per square centimeter.

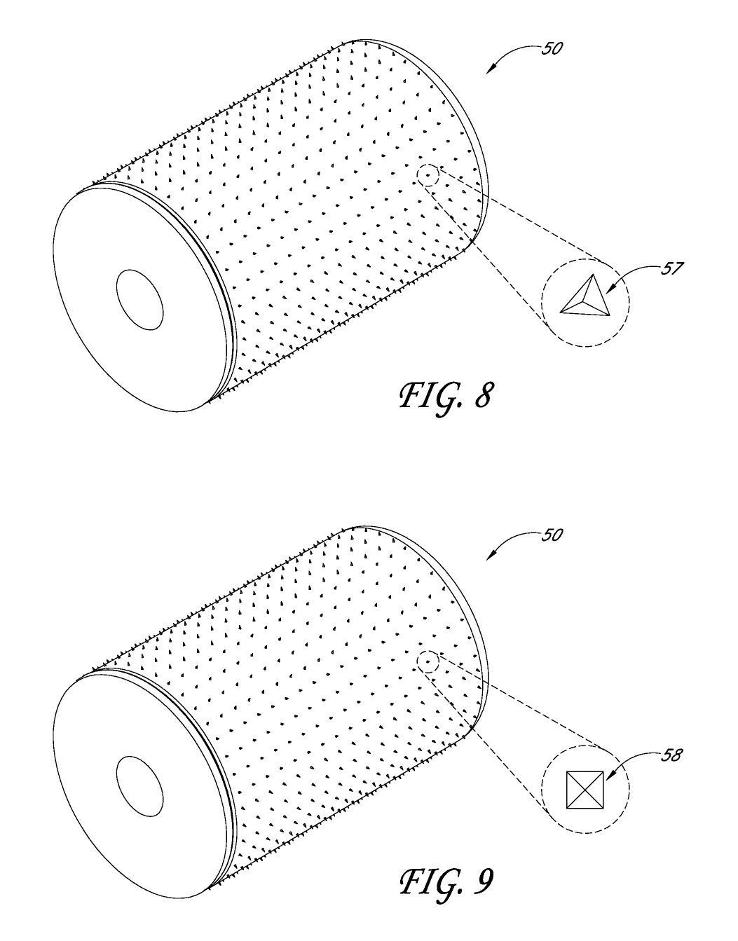

In one embodiment, as illustrated in FIG. 8, the microstructure are shaped as triangular pyramids 57 having three sides. In some embodiments, the triangular pyramid is symmetrical and the lengths of the sides of the base are about the same size. In other embodiments, the triangular pyramid is asymmetrical. In some embodiments, the height of the microstructure can be about 0.35 mm. In some embodiments, the triangular pyramid 57 can be formed through injection molding, wherein a multipiece injection mold tool can be used and the faces of the pyramid are each formed by three different components of the injection mold tool. In other embodiments, some or all microstructures 56 have a different shape that is advantageous for making punctures in dermal areas, such as the 4-sided pyramid 58 illustrated in FIG. 9. The four-sided pyramid microstructure 56 generally provides a stronger element that is less likely to break during use.

In some embodiments, the microstructures 56 can be formed integrally with the cartridge 50. For example, the microstructures 56 can be formed during the injection molding process concurrently with the base 52. This technique advantageously minimizes production costs and the number of parts. In other embodiments, the microstructures can be formed or molded on one or more sheets that can be attached around an outer surface of the base 52.

In some embodiments, the cartridge can have a slightly frustoconical shape, wherein one end of the cartridge has a larger diameter than the other end of the cartridge. The frustoconical shape can be advantageous for producing the cartridge through a molding process. For example, a frustoconical shape allows a molded cartridge 50 (or base portion 52) to be more easily removed from a tool. Tapered sides allow the cartridge 50 to be removed from a mold without damaging the microstructures 56. In some embodiments, the tapered or frustoconical cartridge has a taper angle of at least 0.5 degrees. In addition, the varying diameter of the frustoconical shape allows the user to treat hard to reach places of the patient's body that would otherwise require smaller diameter rollers. Therefore, by providing a tapering roller, the user does not need to change roller assemblies or cartridges during use.

In some embodiments, the cartridge is made of a rigid plastic, metal or composite material. The roller apparatus 10 is includes a disposable cartridge that is sterilized before use and then disposed of after use. In such embodiments, plastic material is often used to manufacture the cartridge as it has it's a low cost and is easy to manufacture. For example, in some embodiments, the cartridge 50 is made from a plastics such as high density polyethylene (HDPE), Delrin®, polypropylene, and/or Teflon.

There is generally a tradeoff between hardness and flowability when considering which material to use. For example, if the plastic is hard, it typically has good flow characteristics but is brittle and can break easily. On the other hand, if the plastic is soft, it typically has less risk of breaking, but has poor flow characteristics during the molding process, which makes it difficult or impossible to form microstructures having dimensions suitable for effective dermal treatments. In one embodiment, to overcome this compromise and to obtain both suitable hardness and flowability, the plastic material is filled with or mixed with or includes a glass. The glass helps the plastic to be rigid without being brittle, while allowing the plastic to flows well during the molding process. These types of material can be particularly advantageous to form the microstructures 56, as microstructures 56 are formed by flowing the plastic material into small mold and should be strong and hard after solidification such that they don't break off during use. In one embodiment, the microstructures 56 are formed from a plastic that includes a polyamide copolymer with 40% glass fibers. Such plastics may be sterilized and reused, as well.

In some embodiments, the roller includes a metal cartridges. The metal cartridge can be made by a casting process. In some embodiments, metal cartridges can be used as multiple use cartridges. In these embodiments, the metal cartridges are advantageously sterilizable and reusable. Some non-limiting examples of metallic material for use in making the cartridges are stainless steel, aluminum and nickel.

### Strips

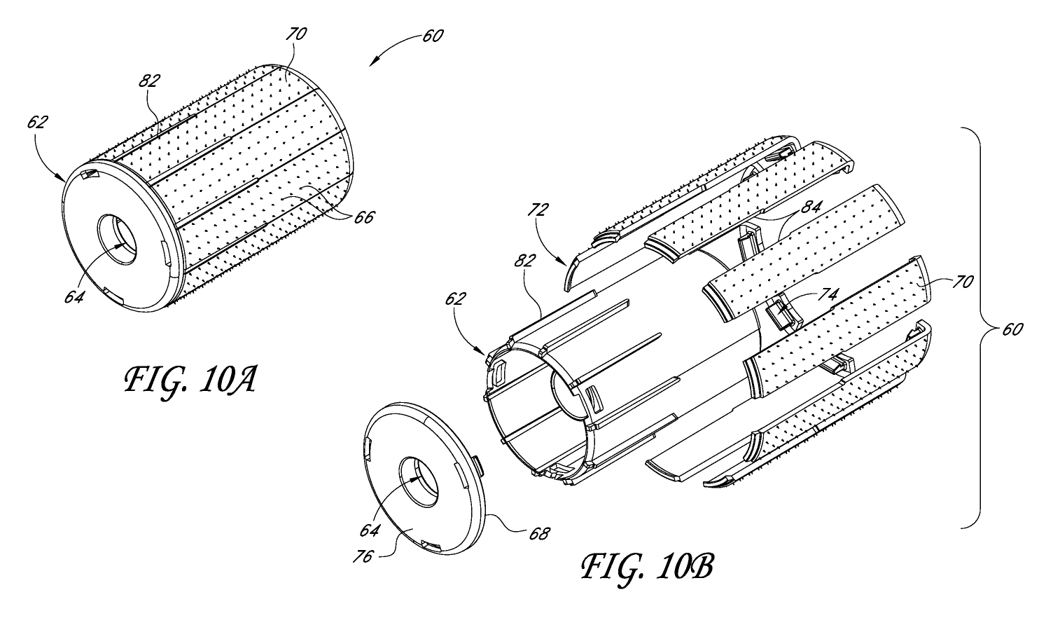

Referring to FIG. 10A, in some embodiments, the cylindrical cartridge 60 includes a base 62 with mechanical features to attach an array of strips 70, each strip having a plurality of microstructures 66 on its outer surface. Similar to the cartridge described above, the base 62 includes a lumen 64 through the center of the cartridge 60 to accept an axle 30. The strips 70 can be attached to the base 62 through any of a variety of mechanisms, including fasteners, hooks, tabs, and/or adhesives, etc.

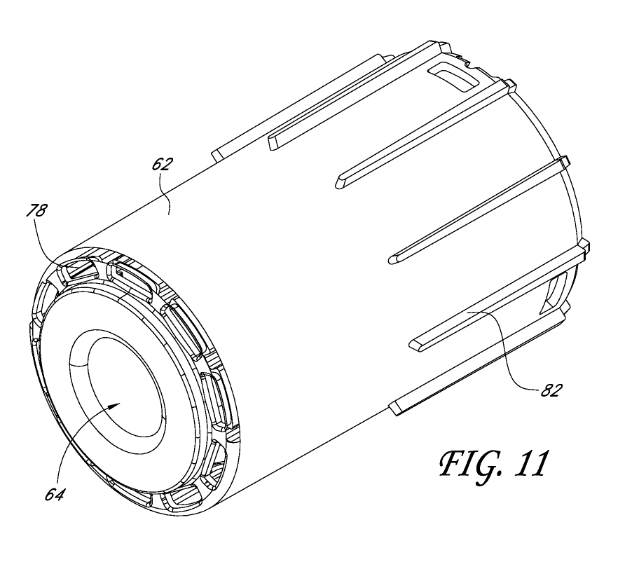

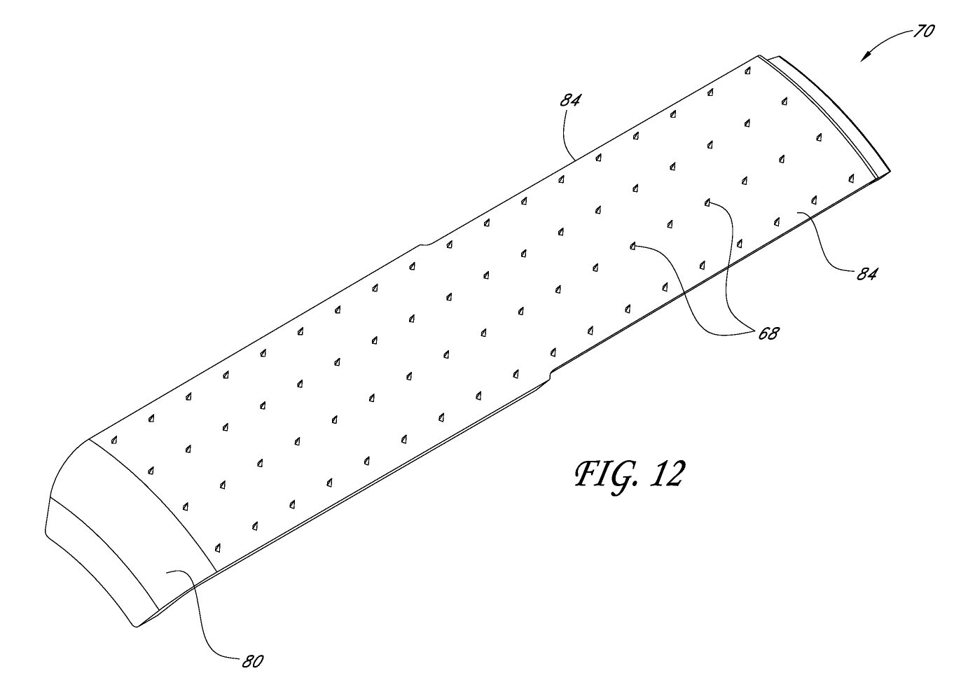

For example, in the illustrated embodiment of FIG. 10B, the strips 70 have mechanical tabs 72 and hooks 74 that couple with the base 62. The base 62 includes an end cap 76 that couples with an end of the base 62. The tabs 72 are retained under a flange 68 of the end cap 76 to secure the end of tabs. The other end of the strips 70 have curved ends 80, as illustrated in FIG. 12, with hooks 74 that couple to slots 78 on the other end of the base 62. The slots 78 can be seen in FIG. 11. In some embodiments, the curved ends 80 of the strips 70 can have a minimum end radius of about 0.4 mm for increased aesthetics and comfort to the patient during treatment.

In some embodiments, the base 62 has rails 82 disposed on the outer surface of the base 62 that extend along at least a portion of the longitudinal length of the base 62, as illustrated in FIG. 11. The rails 82 aid in assembly by correctly aligning the strips 70 to the base 62. In some embodiments, the width of the rails 82 is tapered so that the rails are widest at one end of the base 62 and taper inward as they extend along the longitudinal length of the base 62. Correspondingly, the strips 70 can have complementary slots 84 along the portions of the edges of the strips 70 that mate with the rails 82, as illustrated in FIGS. 10B and 12. Thus, the rails 82 can enhance ease of manufacturing because the strips 70 can be easily and quickly installed between the rails 82 to align the strips 70. The rails 82 also advantageously help avoid damage to the microstructures by minimizing the handling time of the strips 70 during installation.

In some embodiments, the top surface of the rails 82 are generally flush with the top surface of the strips 70 when installed. This can provide a visual cue to ensure proper installation of the strips 70 to the base 62. The flush surfaces also advantageously provide an integrated look and pleasant aesthetics to the cartridge 60. Furthermore, the flush surface avoids a situation where the rails 82 may be too high, which can result in interference with the microstructures' ability to properly contact the patient's derma.

The use of strips 70 advantageously allows customization of the microstructures on the cartridges 60. Several different types of strips 70 having various microstructure designs can be provided and assembled with a common base 62 design. Depending on the desired therapy, the strips 70 having the proper microstructures can be selected and assembled with the base 62. Thus, manufacturing costs can be reduced by being able to produce variations of only strips 70, instead of having to manufacture variations of entire cartridges 60. In some embodiments, different types of strips having different microstructures can be provided on a single base 62.

The strip design of some embodiments of the cartridge 60 is advantageous in reducing waste during manufacturing. Sometimes, errors in manufacturing can produce defective parts that must be recycled or discarded. For cartridges 60 having strips 70, the defective strip can be discarded instead of the entire cartridge having to be discarded. Furthermore, because of manufacturing limitations, it can be easier and more cost effective to manufacture the strips 70 and base 62 separately rather than the entire cartridge 60 as a single piece. For example, the molding process for the entire cartridge can require a multiple piece cast and complex manufacturing procedures to ensure proper migration of the mold material into the small areas of the cast, whereas smaller, thin strips can be molded with no complications.

The material for the strips 70 and base 62 can be similar to the materials discussed above for the cartridge without strips. For instance, the strips 70 are beneficially made of a glass reinforced polymer that give it desired flow characteristics when being molded and the high strength once it is hardened. The base 62 can be made of a rigid plastic, metal or composite material, such as high density polyethylene (HDPE), Delrin®, polypropylene, and/or Teflon, etc.

Similar to the embodiments described above, a plurality of microstructures 56 can be disposed on the outer surface of the strips 70 along the length and width of the strips 70. The spacing between microstructures 56 can be selected for effective patient treatment. For example, in one embodiment, the distance between microstructures 56 is about 4 mm. In some embodiments, the spacing between microstructures 56 falls within the range of from about 2 mm to about 6 mm. In some embodiments, the spacing between microstructures 56 is in the range of from about 3 mm to about 5 mm. Similarly, the density of microstructures can be selected for effective patient treatment. In one embodiment, the density is about 9 needles per square centimeter. In other embodiments, the density is within the range of from about 4 needles per square centimeter to about 20 needles per square centimeter. In some embodiments, the density is in the range of from about 6 needles per square centimeter to about 15 needles per square centimeter.

In some embodiments, the strips 70 include a label or marking that indicates the type of strip, for example, the number “300”. The “300” can indicate the height of the microstructure in micrometers. In other embodiments, the number can represent any other identification, such as the total number of microstructures on the strip, density of the microstructures, or a special code that represents the needle characteristics, such as height, density, shape, etc.

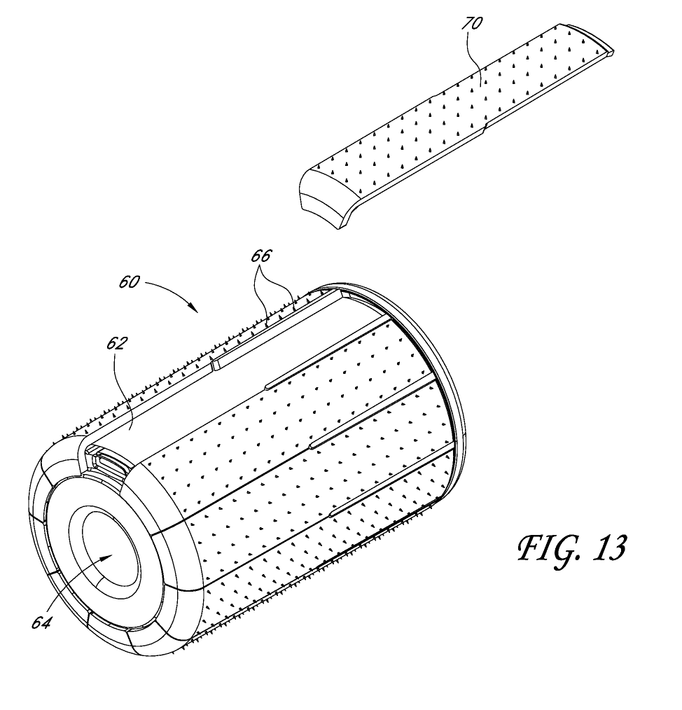

FIG. 13 depicts a cartridge 60 with a conical roller base 62 having mechanical features for attaching an array of microstructure strips 70 having a plurality of microstructures 66 on each strip. The conical roller base 62 includes a lumen 64 configured to receive the axle 30 and to attach to the conical roller base 62 to the handle 20. The microstructure strips 70 can be attached by sliding each strip 70 onto the base 62 until the mechanical features on the strip couple with the complementary features on the base 62 to secure the components together. In one embodiment, the strips 70 are not intended to be removed from the base 62 by the user. Removing strips 70 from the base 62 could cause damage to the microstructures 66, strips 70 or base 62. However, in some embodiments, the strips 70 are configured to be exchanged or replaced by the user. In such embodiments, strips having different sized microstructures can be selected and used together, and damaged strips may be easily replaced.

Depending on the situation and treatment requirements, different strips 70 can be attached to the base 62 to create a customized cartridge. For example, in some embodiments, strips 70 having a high density of microstructures can be used while in other embodiments, strips 70 with a low density of microstructures can be used. In some embodiments, several different types of strips 70 can be used on a single base 62 for a tailored treatment protocol. For example, in some embodiments, the base 62 includes alternating strips 70 of high and low density microstructures and/or taller and shorter microstructures.

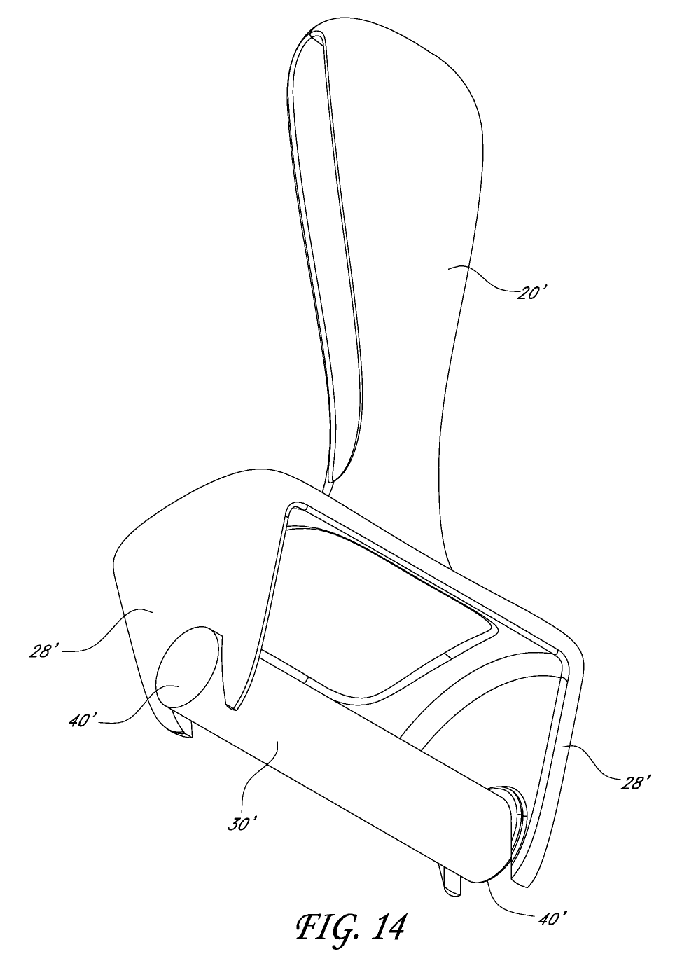

In other embodiments, the handle 20′ includes double axle supports 28′ to attach the axle 30′, as illustrated in FIG. 14. The handle 20′ includes a retention mechanism 40′ which can be used to disengage a cartridge 60′ from the handle for replacement purposes. These embodiments advantageously provide improved balance weight distribution to the cartridge as a result of the double axle supports 28′. It should be understood that these embodiments can include any of the features of the other embodiments discussed above.

### Container

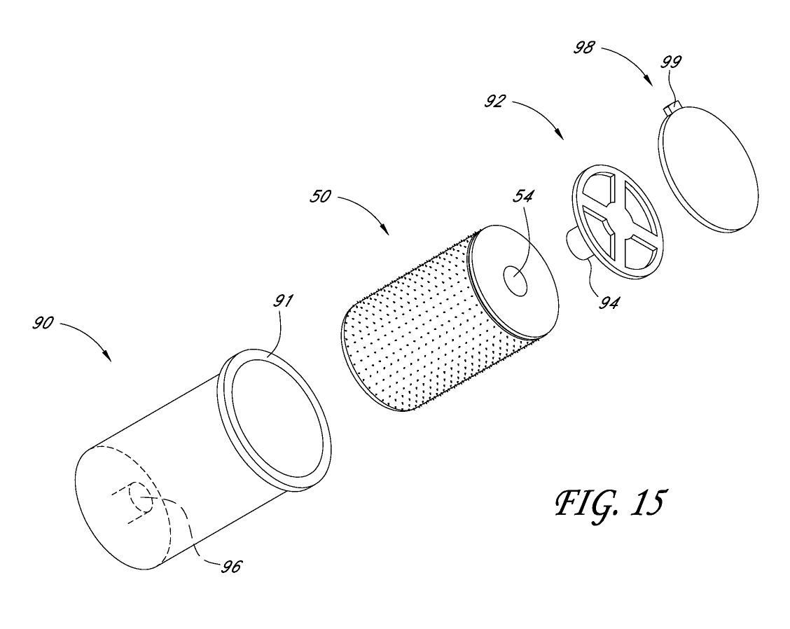

With reference to FIG. 15, in some embodiments, the cartridge 50 is provided or delivered to the technician in a container 90. A stabilizer 92 can be placed on top of the cartridge 50 to secure the cartridge 50 within the container 90 and restrict its movement. By restricting its movement, the sides of the cartridge 50 do not contact the sides of the container 90 during transport and/or storage, which can lead to damage of the microstructures 56. For example, in the illustrated embodiment, the stabilizer 92 has a protrusion 94 that fits in the lumen 54 of the cartridge 50. The stabilizer 92 extends radially outward from the protrusion 94 beyond the diameter of the cartridge 50, such that the outer edges of the stabilizer 92 contact or brace the cartridge 50. The bottom of the container 90 includes a bottom protrusion 96 configured to be inserted insert into the lumen 54 of the cartridge 50 and to secure the bottom of the cartridge 50. Thus, the cartridge 50 can be constrained by the stabilizer 92 on top and the bottom protrusion 96 on the bottom. Although the container 50 is described herein in conjunction with an embodiment of a cartridge 50, the container 90 is not limited to the illustrated embodiment of cartridge 50 and other embodiments of the cartridge, such as the cartridge 60 with strips 70, can also be used with the container 90.

The container 90 can be made of any type of rigid material, such as for example metals, plastics, films, and/or composites. For example, the container 90 can be made of a polyethylene plastic that is sufficiently strong and rigid so that the walls of the container 90 do not deform to the point where they contact the sides of the cartridge 50. Furthermore, the container 90 can preferably be made of a material that can withstand sterilization techniques (e.g., steam sterilization, chemical vapor sterilization, etc.) without degrading in material strength or integrity.

A cover 98 seals the cartridge 50 inside the container 90 and protects it from contamination. In some embodiments, the cover 98 includes a pull tab 99 for easier grasping of the cover 98 during opening of the container 90. In the illustrated embodiment of FIG. 15, the cover 98 is a flat circular component made of an interwoven material that is sealed to a lip 91 on top of the container 90, such as through adhesives or ultrasonic welding. In other embodiments, the cover can seal to the side wall of the container 90. In some embodiments, the cover 98 includes printed identification of the contents of the container 90, such as the density or size of the microstructures on the cartridge. The cover 98 can have warnings, such as an expiration date and an icon indicating that the product is for single use.

In other embodiments, the cover includes a lid that can be attached onto the container 90, such as through threads, fasteners, or a snap fitting. In another embodiment, the container 90 includes a sealed lid with a pull tab and a weakened path wherein the tab can be pulled to open the lid along the weakened path, similar to sealed canned products or a perforation.

In some embodiments, once the cover 98 has been removed from the container 90, it cannot be reattached to the container 90. By providing such a cover it will be immediately apparent to a user when a sterile seal has been broken. However, in some embodiments, the cover 98 can be resealed after it has been removed from the container 90, especially where sterile cartridges are not important. In other embodiments, there can be some other means of indicating to the user that the container has been used and that the container contents may not be sterile. For example, the cover 98 can have an indicator that is torn or broken the first time the cover 98 is opened, thus indicating that the sterile seal has been compromised even if the cover is resealed.

In one embodiment, the cartridge can be sterilized before or after being placed in the container 90. In some embodiments, the cover 98 can be made of a gas permeable material, such as Tyvek®, which allows the cartridge to be gas sterilized inside of the container 90. The Tyvek® also protects the cartridge from fluids and solids during transport. The advantage of first packaging the cartridge and then sterilizing is the ability to ship the cartridge right after sterilization, which reduces the amount of handling of the cartridges and the chances of contaminating the sterilized product. However, in some embodiments, the cartridge can be sterilized and then placed in the container 90 in a clean controlled environment before being sealed. In some embodiments, the cartridge 50 and open container 90 can be sterilized together and then sealed.

### Use of Roller

One embodiment of a procedure for using a roller apparatus 10 is described below. The technician can first select the proper cartridge for the desired application. For example, for purposes of stimulating the collagen in the patient's skin, the technician may use a cartridge with densely grouped, low height microstructures; whereas a cartridge for helping absorb anesthetics may require less densely grouped, yet taller microstructures.

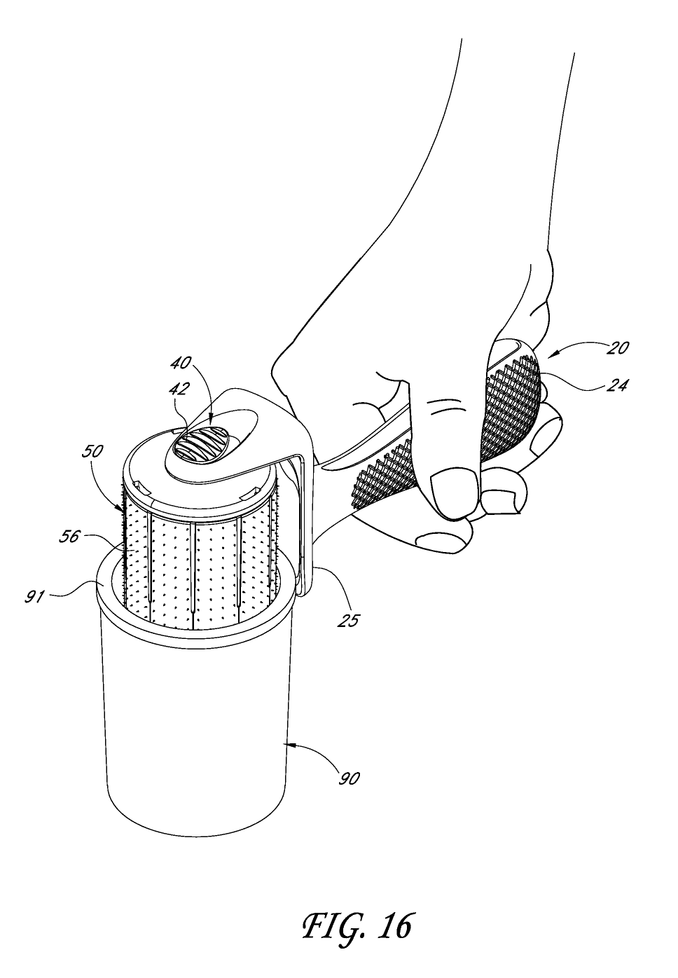

The technician can open a container 90 by removing the cover 98 to gain access to the cartridge 50. While holding the grip portion 24 of the handle 20, the technician can insert the axle 30 into the lumen 54 of the cartridge 50 until the retention mechanism 40 secures the cartridge 50 to the handle 20. The distance from the tube 32 on the axle 30 and the flared end 25 of the handle 20 is wide enough to accommodate the width of the cartridge 50 and the container 90, as illustrated in FIG. 16. For example, the width of the lip 91 on the container 90 is less than the distance between the longitudinal axis of the axle tube 32 and the flared end 25 of the handle 20. In some embodiments, the curvature of the flared end 25 can correspond to the curvature of the container 90 to provide clearance during removal of the cartridge 50 from the container 90. Thus, the handle 20 is configured to remove the cartridge 50 from the container 90 without the technician touching or contaminating the cartridge 50. The empty container 90 can be discarded or placed aside.

In use, the roller apparatus 10 can be held by the technician such that the proper amount of weight is transferred from the handle to the patient. For example, to transfer less of the handle weight to the patient, the technician can hold the handle 20 such that the fulcrum of the handle weight is closer to the neck of the handle. To provide more handle weight to the patient, the technician can place his/her hand further back on the handle, such that the fulcrum of the handle weight is closer to the back end of the handle 20. The proper placement of the technician's fingers can be identified by marks or graduations on the handle. In preferred embodiments, the weight of the handle 20 can be sufficient for proper treatment of the patient. However, in some embodiments, the technician can tailor the pressure applied to the patient's dermal areas to be less than or greater than the weight provided by the handle 20.

The application of the proper amount of pressure to the microstructures can be important to the effective and proper treatment of the patient. As described above, the weight of the handle and the method of using the handle weight to provide the appropriate amount of pressure to a patient's dermal areas can provide a consistent and reliable treatment technique. The variations in the amount of pressure applied by a particular technician can be controlled, such that the applied pressure is not affected by the technician's estimation or dependent on the strength of the technician. Thus, safety in the treatment technique can be improved by helping avoid improper pressures and standardizing the pressure applied during treatment of patients.

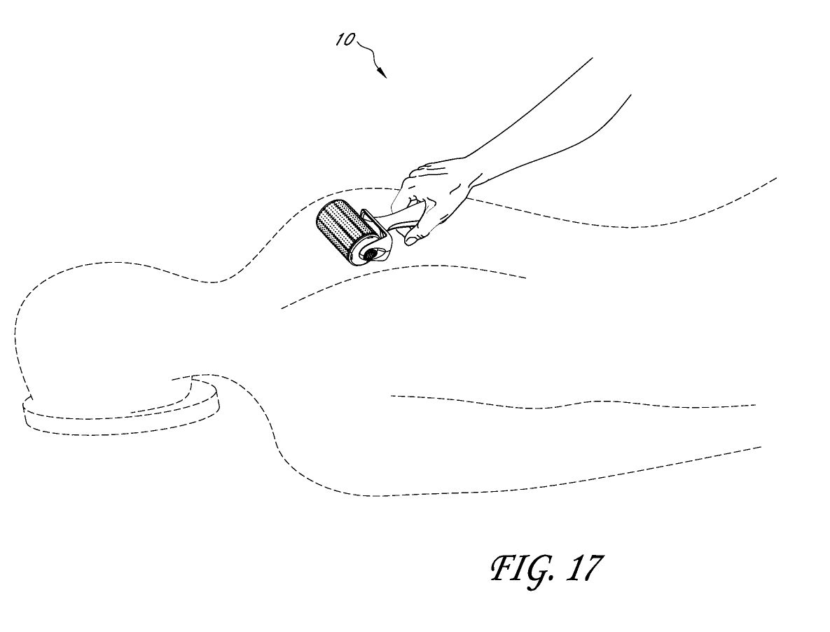

During treatment, the roller apparatus 10 can be applied to the desired dermal areas of the patient, as illustrated in FIG. 17. The cartridge is rolled on the patient's skin in a back and forth motion so that the microstructures can create small punctures in the patient's derma. In some embodiments, several passes of the roller apparatus can be made over the same area of a patient's skin to achieve the desired density of punctures in that portion of the patient's skin. The proper drugs or topical aides can be applied before, during, and/or after treatment with the roller apparatus 10. Because of the size of the roller apparatus and the rolling microstructure cartridge, the roller apparatus 10 can quickly and effectively treat large dermal areas. The roller apparatus 10 is easy to use and requires little training to learn to use the apparatus.

After treatment of the patient is complete, the technician can dispose of the cartridge easily, preferably for recycling. The retention mechanism is configured for easy operation without touching the used cartridge. For example, in the illustrated embodiment of FIG. 16, the pad 42 of the retention mechanism 40 can be manipulated by the technician's thumb. The roller apparatus 10 can be held such that the pad 42 is facing upward, opposite the direction of gravity. Then, by manipulating the pad 42, the tab on the retention mechanism 40 can release the cartridge 50, which may then fall by the force of gravity into a rubbish or recycle bin, or back into the container 90 for reuse.

In other embodiments, the retention mechanism can have a button that when pressed releases the cartridge from the handle. In still other embodiments, the retention mechanism can have a switch that releases the cartridge. In other embodiments, some other form of retention mechanism can be used to efficiently retain and release the cartridge from the handle. However, the retention mechanism is preferably operated with one finger or one hand, which can free up the other hand for other tasks.

Therefore, the technician can use the roller apparatus to effectively apply sterilized or non-contaminated microstructures to the patient's dermal areas without touching or contaminating the cartridge. Some other advantages of the roller apparatus disclosed herein are ability to treat large dermal areas, measured control of the application pressure of the microstructures, and low cost of component production.

Although certain embodiments, features, and examples have been described herein, it will be understood by those skilled in the art that many aspects of the methods and devices illustrated and described in the present disclosure may be differently combined and/or modified to form still further embodiments. For example, any one component of the infusion systems 100 illustrated and described above can be used alone or with other components without departing from the spirit of the present invention. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by a fair reading of the claims that follow.

What is claimed is:

1. A handheld roller assembly for treating a patient's dermal surface, the assembly comprising:
a handle having a longitudinal axis, a proximal end and a distal end;
an axle disposed toward the distal end of the handle, the axle extending substantially transverse to the longitudinal axis of the handle;
a roller cartridge having an outer surface and lumen configured to slideably receive the axle, the lumen extending longitudinally along a central axis of the roller cartridge;
a quick-release mechanism configured to secure the roller cartridge to the axle and release the roller cartridge from the axle; and
a plurality of microstructures extending normal to the outer surface of the roller cartridge.

2. The handheld roller assembly of claim 1, wherein the quick release mechanism comprises a tab configured to detachably hold the roller cartridge on the axle while not impeding rotational movement of the roller cartridge about its longitudinal axis.

3. The handheld roller assembly of claim 1, wherein the quick release mechanism is configured to be manipulated by a thumb of a user's hand when the user's hand is holding the handle.

4. The handheld roller assembly of claim 1, wherein the handle has a weight configured to provide a therapeutic pressure to the patient's dermal surface during use.

5. The handheld roller assembly of claim 1, wherein the microstructures are integrally formed with the roller cartridge.

6. The handheld roller assembly of claim 5, wherein the roller cartridge is formed by injection molding.

7. The handheld roller assembly of claim 1, wherein the roller cartridge comprises a cartridge base and at least one microstructure strip coupled to the cartridge base.

8. The handheld roller assembly of claim 1, wherein the roller cartridge has a substantially constant diameter along the roller cartridge length.

9. The handheld roller assembly of claim 1, wherein the roller cartridge has a frustoconical shape.

10. The handheld roller assembly of claim 1, wherein at least the outer surface of the roller cartridge and microstructures are made of a polyamide copolymer with glass fibers.

11. The handheld roller assembly of claim 1, wherein the microstructures are spaced approximately 4 millimeters from each other.

12. The handheld roller assembly of claim 1, wherein roller cartridge comprises approximately 9 microstructures per square centimeter over the outer surface of the roller cartridge.

13. The handheld roller assembly of claim 1, wherein the microstructures comprise pyramids having three sides.

14. The handheld roller assembly of claim 1, wherein the microstructures comprise pyramids having four sides.

15. The handheld roller assembly of claim 1, wherein the microstructures comprise microneedles.

16. The handheld roller assembly of claim 1, wherein a spacing along the handle longitudinal axis between the handle and the axle is sufficient to allow the axle to be inserted into a container housing the roller cartridge to attach the roller cartridge to the axle.

17. A roller assembly for treating a patient's dermal surface, the assembly comprising:
a handle, the handle comprising a projecting portion that projected from the handle in a direction transverse to a longitudinal axis of the handle;
a roller cartridge configured to slide over the projecting portion of the handle;
a coupling member configured to automatically lock the roller cartridge to the handle without preventing rotation of the roller cartridge with respect to the handle, and further configured to release the roller cartridge from the handle when activated by a user; and
a plurality of microstructures extending normal to an outer surface of the roller cartridge.

18. A method of using a roller assembly comprising the steps of:
providing a handle configured to receive a roller cartridge, the handle comprising a quick-release mechanism for coupling and releasing the roller cartridge to the handle;
providing a sterile roller cartridge in a protective container, the roller cartridge comprising a plurality of microneedles extending normal to an outer surface of the roller cartridge; and
inserting the handle in the roller cartridge while the roller cartridge is in the protective container until the quick-release mechanism locks the handle to the roller cartridge.

19. The method of claim 18, further comprising extracting the roller cartridge from the container.

20. The method of claim 18, further comprising manipulating the quick-release mechanism to detach the roller cartridge from the handle.
